(19) United States
(12) Patent Application Publication
(10) Pub. No.: US 2013/0084135 A1
(43) Pub. Date: Apr. 4, 2013

(54) APPARATUS AND METHOD OF LAYING PIPELINE

(71) Applicant: John Duncan Cruickshank, Kincardineshire (GB)

(72) Inventor: John Duncan Cruickshank, Kincardineshire (GB)

(21) Appl. No.: 13/578,591

(22) PCT Filed: Feb. 11, 2011
(86) PCT No.: PCT/GB2011/050262

§ 371 Date: Dec. 15, 2012

(30) Foreign Application Priority Data
Feb. 11, 2010 (GB) 1002304.2

(51) Int. Cl. F16L 1/18

(52) U.S. Cl. CPC F16L 1/18
USPC 405/167; 405/166; 405/170

(57) ABSTRACT

A method and apparatus for laying pipeline from a vessel. The vessel has pipelaying equipment including apparatus for fabricating pipeline along a fabrication axis, a stinger pivotable between a deployed configuration and a retracted configuration, and a tower pivotable between a lowered configuration and an elevated configuration. The method includes a) pivoting the stinger away from the deployed configuration and into the retracted configuration when it is desired to attach a module to the pipeline, b) before or after step a) attaching a module to the pipeline. Further, c) lowering the section of pipeline from the tower along the departure axis until the attached module is below the retracted stinger, and d) pivoting the stinger away from the retracted configuration and into the deployed configuration to allow continued laying of fabricated pipeline.

### FIELD AND BACKGROUND DISCUSSION

The present invention is concerned with apparatus and a method of laying pipeline from a vessel having pipelaying equipment. The invention is concerned particularly, but not exclusively, with a method of laying pipeline from a vessel in an S-lay pipelaying operation, the pipeline having modules such as pipeline end terminations (PLETs), in-line tees (ILTs) or other in-line structures (ILSs) installed thereon. A method of installing pipeline from a vessel in an S-lay operation is also provided. The apparatus of the invention may also enable a pipelaying vessel to be converted easily between S-lay and J-lay configurations.

When laying pipeline from a vessel onto the seabed it is often necessary to provide modules such as PLETs at each end of the pipeline, or ILTs along the pipeline to branch flow of the fluid in the pipeline; however, the method of deploying pipeline from many vessels is ill suited to deployment of such modules. For example, on vessels equipped with a stinger for “S-lay” pipelaying operations, the pipeline being laid will be in tension as it bends over the stinger from the stern of the vessel into the sea below. The magnitude of the tension on the pipe is great enough to elastically bend the pipe, and with such a high level of tension it is not advisable to also attach a normally non-uniform module such as a PLET or ILT; this is because the structural strength of such a structure is greater than the pipeline which tends to create non-uniform bending of the pipeline as it bends over the stinger. Such non-uniform bending increases localised stress on parts of the pipeline which in turn increases the likelihood of the pipe approaching or exceeding its yield strength adjacent the module. Furthermore, certain dimensions of the stinger and other components of the pipelaying equipment are also ill suited to the passage of such modules.

One way of attempting to overcome these problems is to completely bypass the stinger by passing the PLET or ILT on a winch over the side of the vessel away from the laying axis and then recovering it to the laying axis at the other side of the stinger. This allows the PLET or ILT to pass around the laying equipment rather than through it. However, handling such a bulky module in this way can be a complex and time-consuming operation.

An alternative way of overcoming these problems is to collapse part of the stinger and pass the pipe line being deployed from the S-lay equipment to a separate tower for deployment of the pipeline and the bulky module along a near vertical laying axis.

According to the present invention, there is provided a method of laying pipeline from a vessel having pipelaying equipment that includes:
apparatus for fabricating pipeline from successive pipe sections or pipe joints along a fabrication axis which is closer to horizontal than vertical;
a stinger pivotable between a deployed configuration, in which the stinger supports the fabricated pipeline in an arcuate path between said fabrication axis and a departure axis which is aligned with a pipeline suspended beneath the vessel, and a retracted configuration; and
a tower pivotable between a lowered configuration in which the tower lies substantially parallel with the fabrication axis and an elevated configuration in which the tower is substantially aligned with the departure axis, the method comprising the following steps:

a) pivoting the stinger away from the deployed configuration and into the retracted configuration when it is desired to attach a module to the pipeline;

b) before or after step a) attaching a module to the pipeline;

c) lowering the section of pipeline from the tower along the departure axis at least until the attached module is below the retracted stinger; and

d) pivoting the stinger away from the retracted configuration and into the deployed configuration to allow continued laying of fabricated pipeline.

The curvature of the suspended pipeline and hence the angle of the departure axis relative to the vessel's longitudinal axis will vary depending upon the depth of the laying operation. In a deep sea laying operation, the departure axis will be substantially vertical; however, in a shallow laying operation, the departure axis will be much shallower and may indeed be closer to horizontal than vertical. When in the elevated configuration, the tower is substantially aligned with this departure axis.

Preferably, step a) also comprises the step of pivoting the tower away from the lowered configuration and into the elevated configuration and step d) also comprises the step of pivoting the tower away from the elevated configuration and into the lowered configuration.

The suspended pipeline may be supported by the tower during pivoting between the elevated and lowered configurations. A length of the pipeline may also be supported by way of the tower during an S-lay operation when the tower is in the lowered configuration, in particular during fabrication of the pipeline through a series of welding, testing and/or coating operations performed on pipe elements at locations spaced along the vessel.

In a preferred embodiment, the tower and stinger are coupled with one another for simultaneous movement such that in steps a) and d) each serves as a counterweight for the other. Alternatively, the method may comprise decoupling the tower and stinger members and independently moving each between their respective lowered and elevated configurations.

The method may further comprise the step of altering the counterweight provided by the tower or stinger by moving components of the laying equipment on the tower and or stinger.

The method preferably also comprises supporting the weight of the suspended pipeline during steps a) and d) with tensioning apparatus. The support during steps a) and d) may be provided by supporting the suspended pipeline on tensioning apparatus provided on the tower, where the tensioning apparatus pivots with the tower so that the same tensioning apparatus can then be used to control deployment of the pipeline when in the lowered and elevated configurations. Alternatively, the support provided during steps a) and d) may be provided by a hang-off clamp provided on the tower. Abandonment and recovery apparatus can then be used to control deployment of the pipeline when in the elevated configuration.

When it is desired to attach the module to the pipeline being deployed, the method preferably further comprises the step of securing the pipeline being deployed on a hang-off clamp.

Where the module is attached to the pipeline before step a), the method may comprise the steps of:—
securing the pipeline deployed from the vessel with a hang-off clamp aligned with the fabrication axis such that the hang-off clamp holds the deployed pipeline supported by the stinger in the arcuate path between the fabrication axis and the departure axis;
attaching the module to the pipeline upstream of the hang-off clamp; and
then disengaging the hang-off clamp from the pipeline to allow the module to be deployed from the vessel on a section of pipeline.

Where the module is attached to the pipeline after step a), the method may comprise the steps of:—
securing the pipeline deployed from the vessel with a hang-off clamp aligned with the departure axis;
attaching the module to the pipeline above the hang-off clamp; and
then disengaging the hang-off clamp from the pipeline to allow the module to be deployed from the vessel on a section of pipeline.

The step of pivoting the stinger into the retracted configuration in step a) may comprise moving articulated stinger sections such that they collapse out of rigid engagement with one another when the stinger is in its retracted configuration.

The method may also comprise the step of opening firing line doors before step a).

The method may further comprise the step of providing the tower in a retracted configuration and selectively extending the length of the tower to an extended configuration. Actuation of the tower between the retracted and extended configurations may be performed by moving parts of the tower telescopically. Movement of the tower between its extended and retracted configurations may preferably be performed whilst the tower is in its elevated configuration.

The method may also comprise the step of partially recovering a section of pipeline into the tower once the tower has reached the elevated configuration and prior to the module being attached to the pipeline.

When it is desired to configure the vessel for non-pipelaying operations, the method may comprise the steps of:—
at least partially pivoting the tower from its lowered configuration toward its elevated configuration and hence at least partially pivoting the stinger into its collapsed, retracted configuration;
rigidly retaining at least a portion of the stinger in its collapsed configuration; and
returning the tower toward its lowered configuration thereby at least partially lifting the stinger into line with the vessel's longitudinal axis.

Preferably, the stinger is lifted above the water line of the vessel as the tower returns to its lowered configuration.

The step of rigidly retaining at least a portion of the stinger in its collapsed configuration may comprise the step of engaging rigid retaining members with portions of the stinger to prevent the articulated stinger sections from moving relative to one another.

When it is desired to perform a hand over operation, the method may further comprise the steps of:—
at least partially lowering the end of the pipeline below the vessel;
manoeuvring the vessel around the lowered pipeline; and
pivoting the tower further past its elevated configuration into a hand over configuration.

The step of lowering the pipe line below the vessel may comprise suspending the pipeline on a cable below the vessel and winching in the cable and pipeline to the vessel when the vessel has been repositioned for the hand over. Alternatively, the pipeline may be released to the seabed and then recovered to the vessel from the seabed once the vessel has been manoeuvred into position for the hand over.

According to the present invention, there is also provided pipelaying equipment for laying pipeline from a vessel, the apparatus comprising:—
apparatus for fabricating pipeline from successive pipe sections or pipe joints along along a fabrication axis which is closer to horizontal than vertical;
a stinger which is pivotable between a deployed configuration, in which the stinger supports the fabricated pipeline in an arcuate path between said fabrication axis and a departure axis which is aligned with pipeline suspended beneath the vessel, and a retracted configuration; and
a tower pivotable between a lowered configuration in which the tower lies substantially parallel with the fabrication axis and an elevated configuration in which the tower is substantially aligned with the departure axis.

The tower and stinger may be coupled such that they can pivot together as a unit, each serving as at least a partial counterweight for the other.

Alternatively, the tower and stinger may be independently moveable.

Pipeline support means is preferably mounted to the tower such that the support means will pivot along with the tower between the lowered and elevated configurations to thereby support the pipeline at and between these two configurations.

The support means is preferably operable to support the pipeline for S-lay operations when the tower is in the lowered configuration. The support means may comprise a plurality of rollerboxes mutually spaced along the tower.

The support means may comprise tensioning apparatus or alternatively a hang-off clamp provided on the tower. Abandonment and recovery apparatus may also be provided to control deployment of the pipeline when in the elevated configuration.

A hang-off clamp may be provided on the vessel to support the pipeline when it is desired to insert a module into the fabricated pipeline.

The stinger may comprise a single stinger member mounted at one end of the vessel at a pivot axis which is common to the tower pivot axis. Alternatively, the stinger may comprise a plurality of articulated stinger members, at least one of which being mounted at one end to the vessel at the common pivot axis and which, in a first operational configuration, closes into engagement with another of the articulated stinger members to provide a relatively rigid stinger member and in a second, retracted configuration collapses out of rigid engagement with the other articulated stinger members. The articulated stinger members may each be attached to one another by a hinge provided at an upper edge of each articulated stinger member. Preferably, an upper articulated stinger member has a length and position relative to the tower which is arranged such that when the tower is in its elevated configuration, the remaining collapsed articulated stinger members attached thereto will hang from the upper articulated stinger member's hinge to thereby remain retracted from the departure axis along a displaced axis. The displaced axis will normally be aligned with gravity.

This results in a stinger which will rigidly support the pipe being laid when the tower is in the lowered configuration but which will at least partly articulate away from the departure axis when the tower is moved toward the elevated configuration. Furthermore, since the stinger collapses when it is moved into its retracted configuration, it provides good stability whilst remaining clear of the vessel's hull when the tower is moved toward the elevated configuration.

Locking members may be provided to selectively retain the articulated stinger members in the collapsed configuration for stowage. The locking members may comprise a series of hydraulically actuated rigid locking links for insertion between the collapsed articulated stinger members.

The roof of the vessel firing line may be provided with doors which may be opened to allow the tower to pivot from the lowered configuration to the elevated configuration.

The tower may be provided with moveable sections which allow the tower to actuate between a retracted configuration and an extended configuration. The moveable sections may be telescopically moveable.

The pivotable mounting of the tower and stinger may allow the tower to be hinged past its elevated configuration into a temporary hand over configuration.

The inventive concept also embraces pipelaying equipment for laying a pipeline from a vessel, the equipment comprising a tower pivotable between: a lowered configuration in which the tower lies substantially parallel with a pipe fabrication axis that is closer to horizontal than vertical; and an elevated configuration in which the tower is substantially aligned with a departure axis of pipeline suspended beneath the vessel; wherein the tower comprises supports capable of supporting a length of the pipeline on the fabrication axis. To support the pipeline, the tower suitably comprises a series of spaced supports for supporting the pipeline through a series of welding, testing and/or coating operations performed along the fabrication axis.

The pipelaying equipment may further comprise a pipe elevator system, whereby the equipment may be configured for an S-lay operation when the tower is in the lowered configuration, with pipe elements being added to the pipeline in substantial alignment with the fabrication axis; but the equipment may be configured for a J-lay operation when the tower is in the elevated configuration, with pipe elements being raised and oriented by the pipe elevator system and added to the pipeline in substantial alignment with the departure axis.

Welding, testing and/or coating stations positioned for the S-lay operation are preferably also usable to prepare pipe elements for use in the J-lay operation. The tower suitably carries one or more welding, testing and/or coating stations for use in the J-lay operation. However, it is also possible for the tower to be movable relative to one or more such stations for use in the J-lay operation.

The corresponding method of laying pipeline from a vessel comprises pivoting a tower between: a lowered configuration in which the tower lies substantially parallel with a pipe fabrication axis that is closer to horizontal than vertical and supports a length of the pipeline during its fabrication; and an elevated configuration in which the tower is substantially aligned with a departure axis of pipeline suspended beneath the vessel.

A supported length of the pipeline may be pivoted with the tower when the tower pivots between the lowered and raised configurations. Alternatively an S-lay operation may be conducted when the tower is in the lowered configuration and a J-lay operation may be conducted when the tower is in the elevated configuration. It is of course possible to supply prefabricated pipe elements for the S-lay or J-lay operations.

### BRIEF DESCRIPTION OF THE DRAWINGS

Embodiments of the invention will now be described, by way of example only, with reference to the accompanying drawings, in which:

FIG. 1A is a transverse illustration of a pipelaying vessel equipped with S-lay pipelaying equipment. Pipeline is shown being deployed from the vessel firing line along a fabrication axis and over a three sectioned stinger at the stern of the vessel which supports the fabricated pipeline in an arcuate path for subsequent deployment toward the sea bed along a departure axis;

FIG. 1B is a plan view of the vessel of FIG. 1A;

FIG. 2 is a transverse illustration of the vessel where the tower has been pivoted to its elevated configuration and the stinger displaced from the departure axis;

FIG. 3 is a transverse illustration of the vessel where an in line tee (ILT) structure has been attached to the pipeline;

FIG. 4 is a transverse illustration of the vessel where a section of pipeline has been lowered by the laying tower until the ILT is lower than the displaced stinger;

FIG. 5 is a transverse illustration of the vessel where the tower has been returned to the lowered, S-lay configuration with the ILT now deployed from the vessel on its way toward the sea bed;

FIG. 6 is a transverse illustration of the vessel where the tower has been over pivoted with a riser section being retained by a hang-off clamp in preparation for a hand over operation;

FIG. 7 is a transverse illustration showing the first step of a stinger raising operation;

FIG. 8 is a transverse illustration showing the second step of a stinger raising operation;

FIG. 9A is a transverse illustration of a pipelaying vessel equipped with S-lay pipelaying equipment. Pipeline is shown being deployed along the fabrication axis and over a two sectioned stinger at the stern of the vessel which supports the fabricated pipeline in an arcuate path for subsequent deployment toward the sea bed along a departure axis. This embodiment of the invention is set up to install the ILT on the pipeline before the tower is pivoted to its elevated configuration;

FIG. 9B is a plan view of the vessel of FIG. 9A;

FIG. 10 is a transverse illustration of the vessel where the tower has been upended to its elevated configuration, with the ILT suspended on the tower, and the stinger retracted from the departure axis;

FIG. 11 is a transverse illustration of the vessel where a section of pipeline has been lowered by the laying tower until the ILT is lower than the retracted stinger;

FIG. 12 is a transverse illustration of the vessel where the tower has been returned to the lowered, S-lay configuration with the ILT now deployed from the vessel on its way toward the sea bed;

FIG. 13A is a transverse illustration of a pipelaying vessel equipped with S-lay pipelaying equipment. Pipeline is shown being deployed along fabrication axis, through pipelaying equipment and onto a two sectioned stinger at the stern of the vessel for subsequent deployment toward the sea bed along a departure axis. The tower in this embodiment of the invention is extendable;

FIG. 13B is a plan view of the vessel of FIG. 13A;

FIG. 14 is a transverse illustration of the vessel where the retracted tower has been upended and the stinger displaced from the departure axis;

FIG. 15 is a transverse illustration of the vessel where the tower has been extended;

FIG. 16 is a transverse illustration of the vessel where the end section of the pipeline has been retracted up into the extended tower;

FIG. 17 is a transverse illustration of the vessel where the ILT has been installed on the pipeline;

FIG. 18 is a transverse illustration of the vessel where a section of the pipeline has been lowered by the laying tower until the ILT is lower than the retracted stinger;

FIG. 19 is a transverse illustration of the vessel where the tower extension has been retracted;

FIG. 20 is a transverse illustration of the vessel where the retracted tower has returned to the lowered, S-lay configuration with the ILT now deployed from the vessel on its way toward the sea bed;

FIGS. 21A to 21I schematically illustrate the positioning of the vessel and the apparatus of the invention relative to an FPSO in a hand over operation; and

FIG. 22 is a transverse illustration of a pipelaying vessel having a tower adapted for J-lay operations, where the tower has been pivoted to an elevated configuration.

### DETAILED DESCRIPTION OF THE EMBODIMENTS

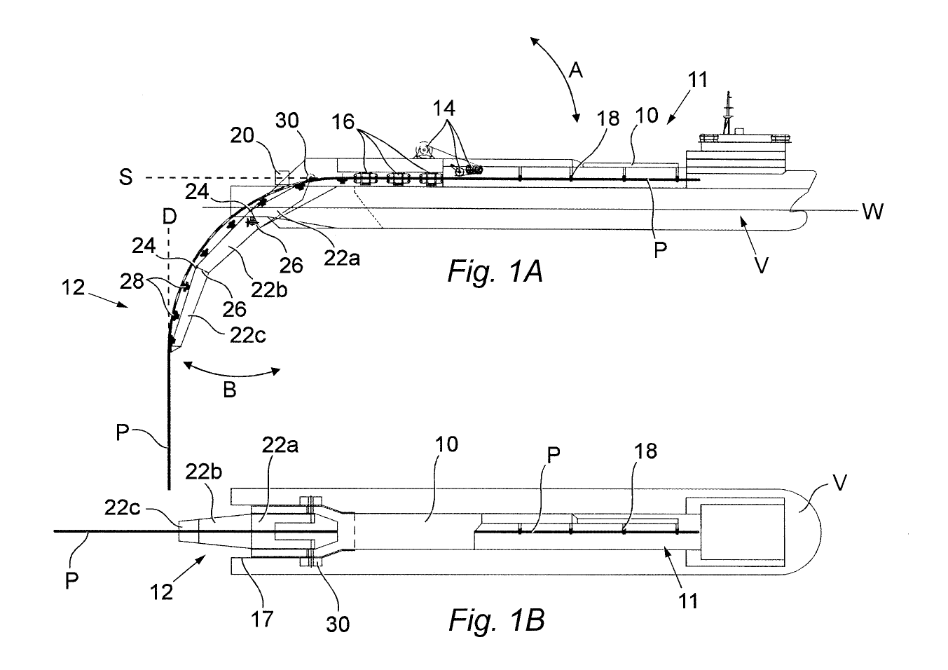

FIG. 1A shows a vessel V comprising a pivotable tower 10 and stinger 12. The tower 10 is provided with pipelaying components such as an abandonment and recovery winch apparatus 14, tensioners 16 and rollerbox sections 18. A hang-off clamp 20 is also provided toward the stern of the vessel.

Referring to FIG. 1B, the stern of the vessel V is provided with a U-shaped cut out 17 to allow the stinger 12 and pipeline P to pass from the vessel into the sea.

In this embodiment the pipelaying equipment includes a stinger 12 having an upper articulated stinger member 22A, a middle articulated stinger member 22B and a lower articulated stinger member 22C. The articulated stinger members are linked to each other by hinges 24. The end face 26 of each articulated stinger member 22A, 22B, 22C is angled such that when it abuts against the end face of the next adjacent articulated stinger member a rigid stinger 12 having a generally curved profile is created. The support provided by the curved stinger 12 is further improved by stinger roller boxes 28 which are appropriately positioned along the upper side of the stinger 12 to provide a smooth curved support profile for the pipeline P as its passes over the stinger 12.

The tower 10 is pivotably mounted to the vessel V at pivot 30 which allows the tower 10 to be pivoted away or towards the vessel's deck in a pivoting action depicted by arrow A in FIG. 1A. The upper end of the top articulated stinger member 22A is also pivotably mounted to the vessel V at pivot 30. This allows the stinger 12 to be pivoted away or toward the hull of the vessel V, in a pivoting action depicted by arrow B in FIG. 1A.

In the present embodiment, the tower 10 and the upper articulated stinger member 22A are rigidly coupled to one another such that pivoting the tower 10 around the pivot 30 results in simultaneous pivoting of the stinger 12 around the pivot 30. The length and mass of the tower 10 relative to the length and mass of the stinger sections 22A, 22B, 22C is selected to at least partly counterbalance the tower and stinger around the pivot 30. This minimises the torque required to pivot the tower 10 and the stinger 12 around pivot 30. The position of components on the tower 10 and/or stinger 12 can also be altered to adjust the degree of counterbalance provided around the pivot 30. For example, the abandonment and recovery winch apparatus 14 may be moveable along the tower 10. Such equipment can often weigh many tonnes; therefore repositioning such a mass on the tower can provide an effective balancing mechanism. In the embodiment shown the abandonment and recovery winch apparatus 14 is shown offset from the longitudinal axis of the tower 10 to improve its balancing capability.

For the majority of the pipelaying operation, the present invention lays pipe in an S-lay configuration. S-lay pipelaying operations are so called since the pipe being laid takes up an S-shaped configuration between the vessel and the sea bed. As the pipe is fabricated at the firing line and leaves the vessel V it initially leaves along a substantially longitudinal fabrication axis which is closer to horizontal than vertical (labelled S in the attached Figs.). The pipeline then passes over a stinger which supports the fabricated pipeline in an arcuate path between the fabrication axis S and a departure axis D which, in the present deep water embodiment, is substantially vertical. This can be used to temporarily lay pipe in accordance with a J-shaped laying profile where the pipe initially leaves the vessel V along a substantially vertical departure axis.

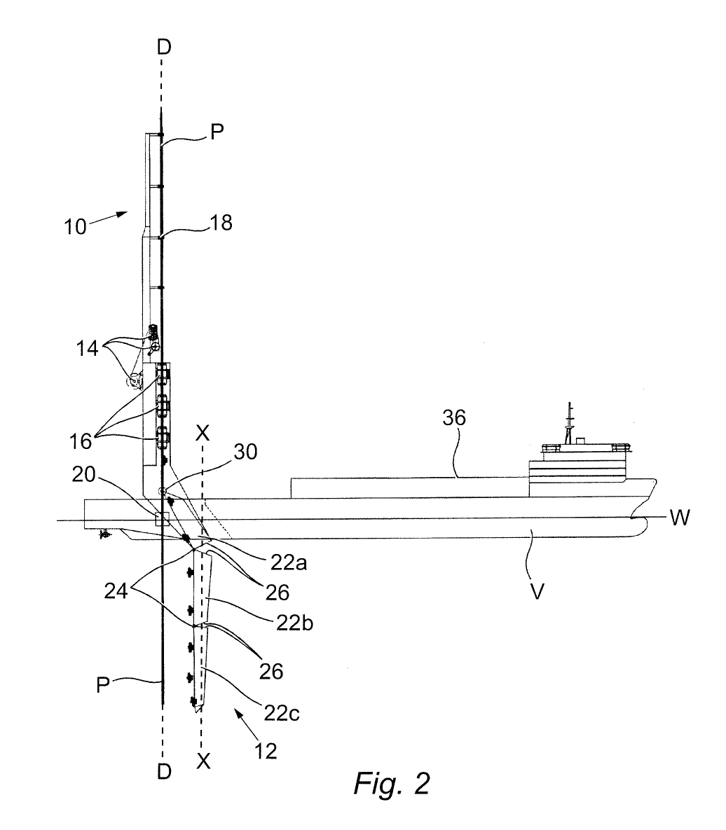

Referring to FIGS. 1A and 1B, during S-lay pipelaying operations, with the tower lowered, sections of pipe are fabricated into pipeline P at a firing line 11 on the deck of the vessel V. Pipe sections may be added one-by-one to the end of the pipeline P or a plurality of pipe sections may be welded together into a pipe joint such as a double-, triple- or quadruple joint and then added together to the end of the pipeline P. As the fabricated pipe leaves the firing line 11 it is passed along the rollerbox sections 18 of the tower 10 toward the stern of the vessel V. Hinged doors 36 seen in FIGS. 2 to 4 may be provided in the roof of the firing line 11. The pipeline P then passes through the tensioners 16 on the tower 10 which hold the weight of pipeline between the vessel V and the sea bed. Once passed through the tensioners 16, the pipeline P bends over the stinger 12 into the sea below, facilitated by the stinger roller box sections 28. Continued fabrication of the pipeline P at the firing line 11 can therefore allow continuous laying of pipeline P from the vessel V.

When it is necessary to include a module such as a non-uniform pipe line end termination (PLET) or in line tee (ILT) on the pipeline P, the following steps are performed.

Fabrication of pipeline P at the firing line 11 is temporarily suspended.

The firing line roof doors 36 are opened and the tower 10 is pivoted from its lowered, S-lay configuration around the joint 30 through approximately 90 degrees to an elevated configuration as depicted in FIG. 2. The torque required to pivot the tower 10 between these positions can be provided by any suitable actuator; for example, an electric or hydraulic motor. As the tower 10 pivots away from the deck of the vessel V, the tensioners 16 and the tower roller box sections 18 retain the upper section of pipe in the tower 10. Since upper stinger section 22A is rigidly coupled with the tower 10 it will also pivot towards the hull of the vessel V around the common pivot 30. As it does so, each articulated stinger member 22A, 22B, 22C opens away from the adjacent stinger member (since the stinger hinges 24 are provided at the top edge of faces 26, the middle and lower articulated stinger members 22B, 22C are free to rotate around the hinges 24 such that they will hang downwards in line with one another off the hinge 24 provided at the edge of the upper articulated stinger member 22A). The middle and lower articulated stinger members 22B, 22C are therefore retracted and align with gravity along a displaced axis X as shown in FIG. 2. Each articulated member of the stinger 12 is therefore retracted away from the departure axis D when the tower 10 is in the elevated configuration.

The pipeline P being laid is then secured by a hang-off clamp 20 provided at the stern of the vessel V in line with the departure axis D. Once the pipeline tension is secured by the hang-off clamp 20, the pipeline P can then be cut above the hang-off clamp 20. At this point the remaining upper section of pipe in the tower 10 is retained there by tensioners 16 and the rollerbox sections 18.

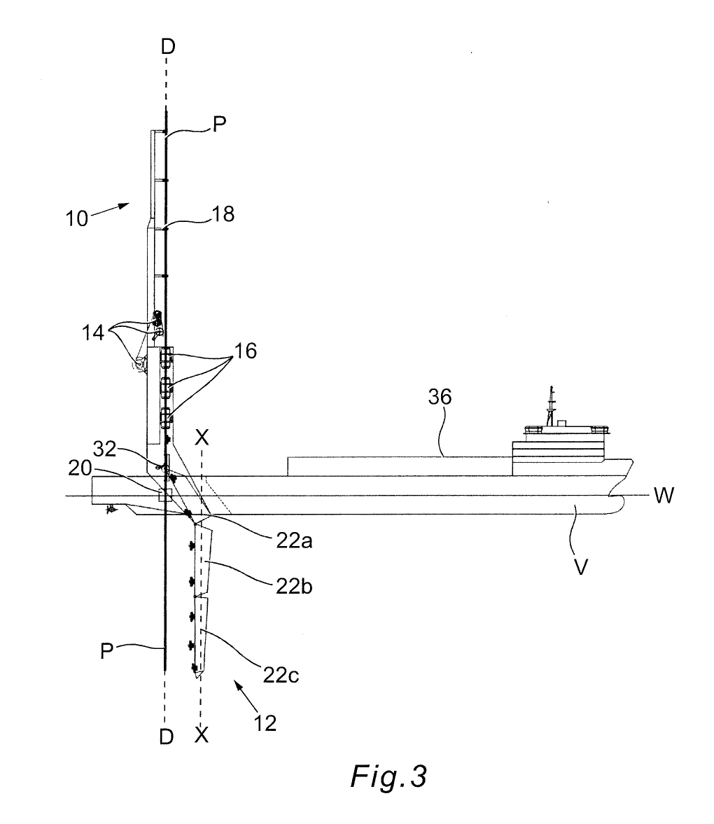

The module, which in this case is an ILT 32, can then be attached between the bottom of the upper section of the pipe and the top of the lower section of pipe as shown in FIG. 3. Once the ILT 32 has been secured to the pipeline P, the hang-off clamp 20 can be disengaged so that the weight of the pipeline P is once again held by the tensioners 16.

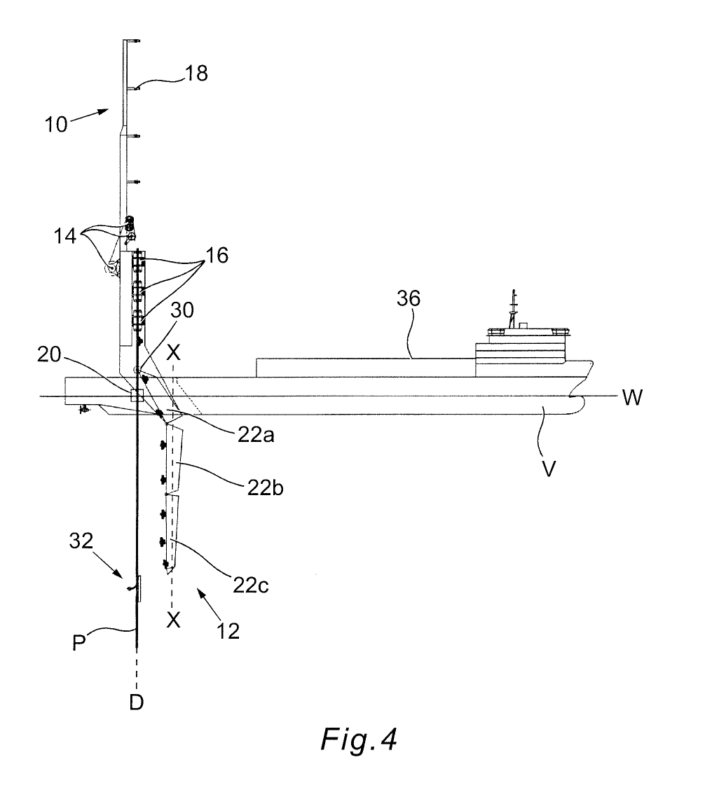

With the sections of the stinger 12 aligned with the retracted axis X, the tensioners can be actuated to slowly lower the pipeline P and the attached ILT 32 into the sea along the departure axis D. As shown in FIG. 4, this is continued until the ILT 32 is below the lowest point of the lower stinger member 22C. The ILT 32 has therefore now cleared the pipelaying equipment. The tower 10 will normally only lay this small section of pipe in this temporary elevated configuration.

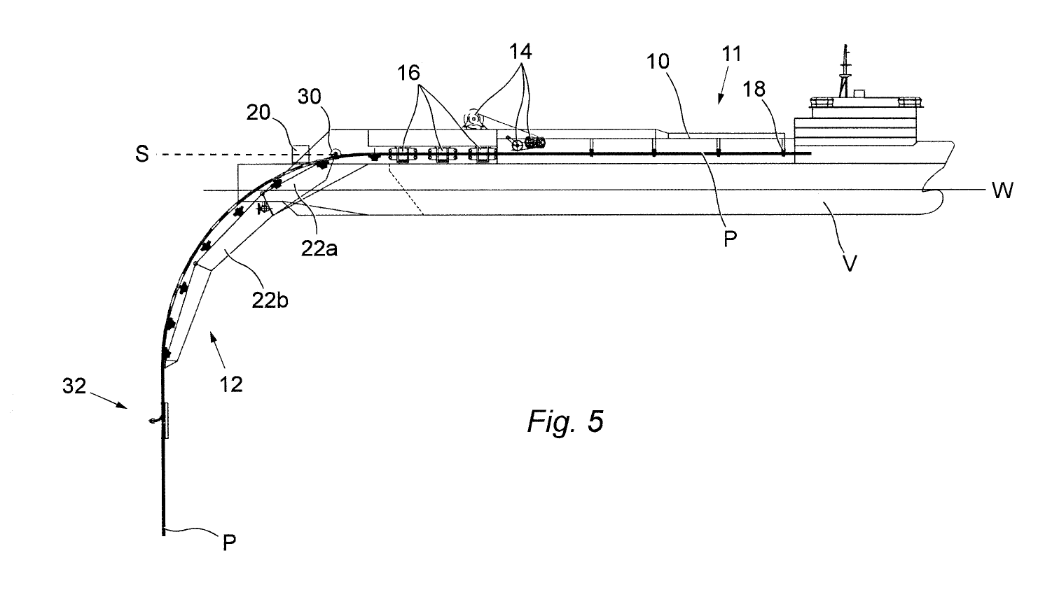

For further laying of pipe, the apparatus is returned to the lowered, S-lay configuration. To do this the tower 10 is pivoted back toward the deck of the vessel V around the pivot 30 until it again lies along the deck of the vessel V. As the tower 10 pivots, the upper articulated stinger member 22 will pivot away from the retracted axis X until its end face 26 abuts against the end face of the adjacent middle articulated stinger section 22B whose end face will in turn abut against the end face of the lower articulated stinger section 22C to again form a rigid stinger member 12. Continued pivoting of the tower 10 brings the lower end of the stinger back into line with the resulting departure axis D and the upper end of the stinger back into line with the axis S as shown in FIG. 5. The firing line roof doors 36 can then be closed and fabrication of pipeline P at the firing line 11, and laying of the pipeline P from the vessel V can recommence.

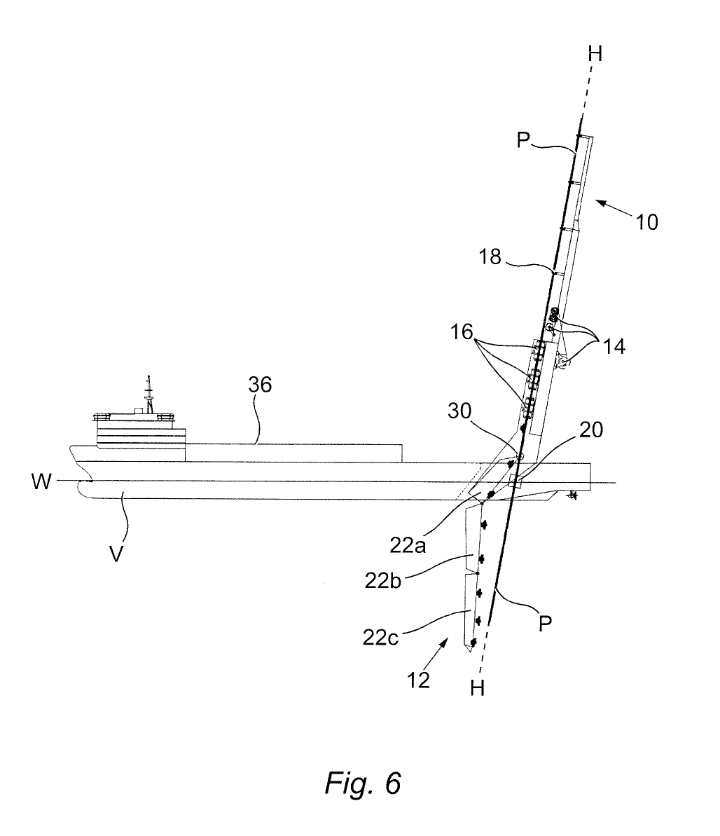

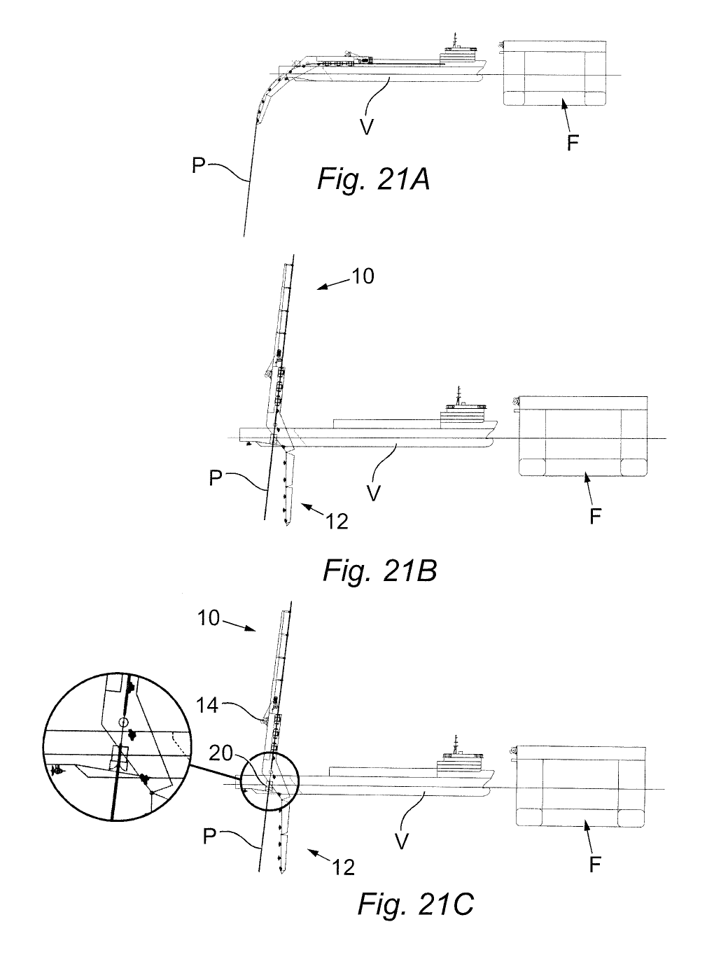

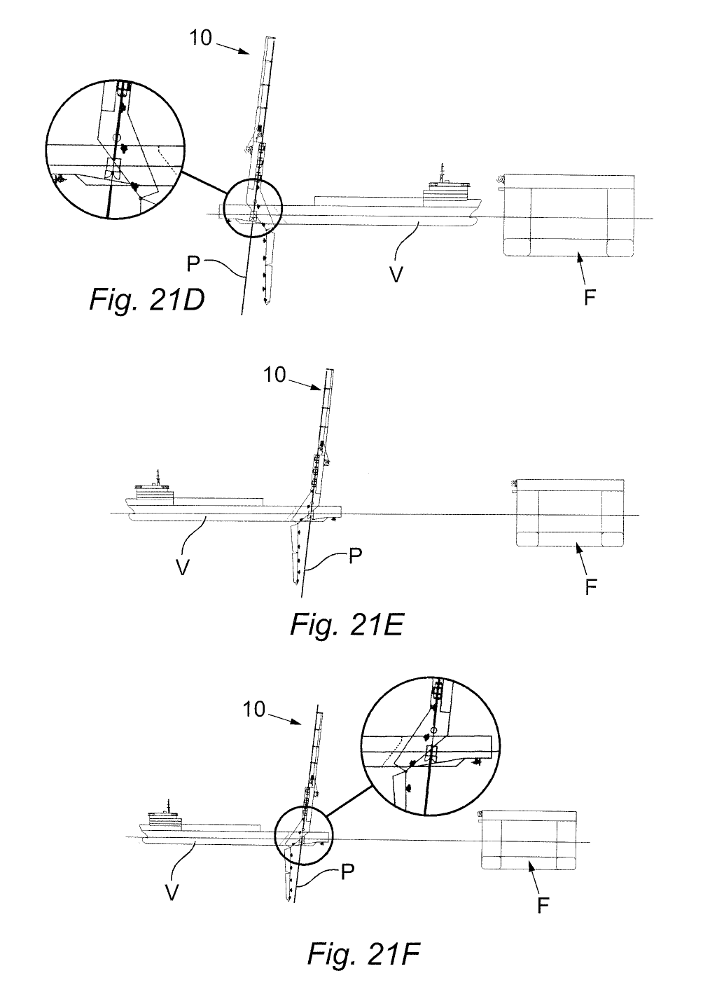

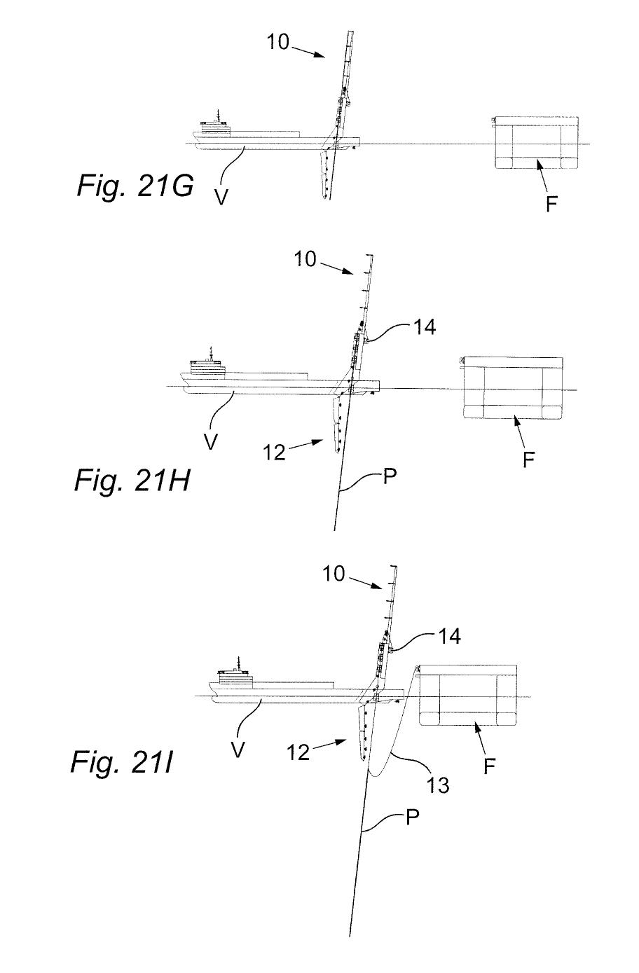

Referring to FIG. 6 and FIGS. 21A to 21I, the tower 10 can also be used to perform a riser hand over operation as follows.

The last section of pipeline P is lowered on a cable until it is below the vessel V. The vessel V can then be maneuvered around the suspended pipeline P and the suspended pipeline P then recovered to the tower 10 on the cable. The tower 10 is pivoted to its elevated configuration, and then further pivoted around joint 30 past the departure axis D until the pipeline P is aligned with a hand over axis H. The pipeline P is retained along the hand over axis H by the box sections 18, the tensioners 16 and the tilted hang of clamp 20. This allows the vessel V to hand over the pipeline P to another vessel or structure such as, for example, a Floating Production Storage and Offloading (FPSO) platform.

The steps involved in handing over the pipeline P to an FPSO structure F are illustrated schematically in FIGS. 21A to 21I. The vessel V approaches the structure F bow-first as shown in FIG. 21A. The tower 10 is then raised to its elevated configuration as shown in FIG. 21B; a padeye termination is attached to the end of the pipeline P. As shown in FIG. 21C the pipeline P is now held by hang-off clamp 20, then cut and padeyes then welded to both cut ends. A wire is then connected to both padeyes and tensioned by the tensioners. As shown in FIG. 21D, the pipeline P is then lowered until the wire section between the two cut ends is below a bell mouth guide provided below the hang-off clamp 20. The vessel V is now rotated 180 degrees around the tower axis (from the orientation depicted in FIG. 21D to the orientation depicted in FIG. 21E). As the vessel V rotates through 180 degrees the tower 10 pivots past its elevated configuration to align with the pipeline suspended beneath the vessel as depicted in FIG. 21E. As shown in FIGS. 21F and 21G, the pipeline P is then raised, clamped with hang-off clamp 20, the wire and pad eyes removed and the upper and lower pipe sections welded back together. The pipeline P is then lowered with the tensioners whilst moving the vessel toward the structure F. Once the pipeline P has been lowered by the tensioners to its fullest extent (FIG. 21H) an abandonment pad eye is attached to the abandonment wire and the tension transferred to the abandonment and recovery winch 14. The tensioners can then be opened. Finally, as shown in FIG. 21I, the pipeline P is then lowered and transferred to pull-in rigging 13 on the structure F in a conventional manner.

In an alternative hand over method, rather than suspending the pipeline P directly under the vessel V, it can be abandoned to the sea bed and then recovered to the vessel V once the vessel has maneuvered into its hand over position.

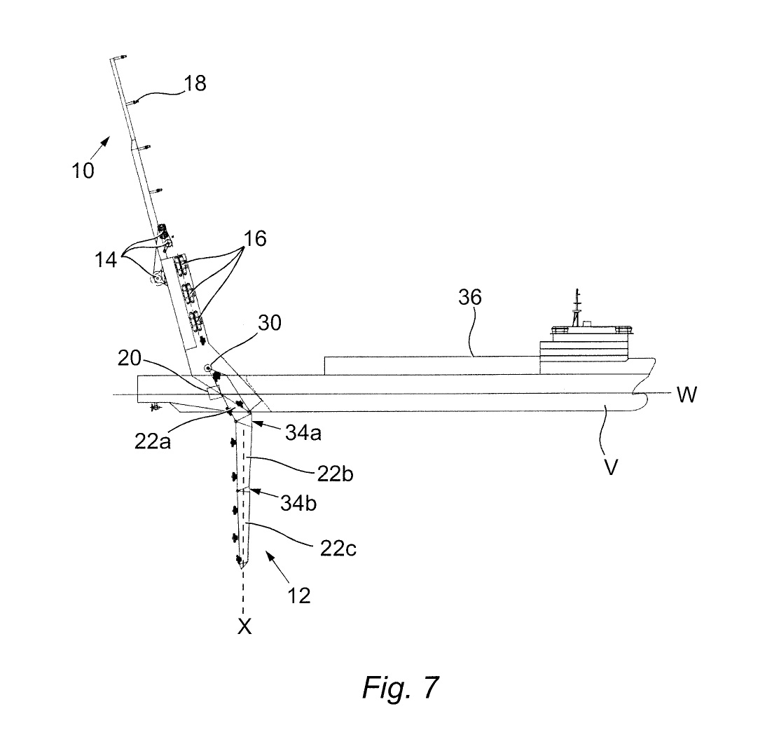

Referring to FIG. 7, when no pipelaying is necessary, it may be desirable to raise the stinger 12 at least partially above the waterline W in order to streamline the vessel V. Again pivoting movement of the tower 10 and stinger 12 around common pivot 30 can be used here to raise the stinger 12. The firing line roof doors 36 are first opened and the tower 10, without any pipeline P present is pivoted past the elevated configuration in a similar fashion to that shown in FIG. 6. This displaces the stinger 12 along a retracted, displaced axis X in a similar fashion as previously described. With the middle and lower articulated stinger members 22B, 22C hanging off the upper articulated stinger member 22A, an upper rigid locking link 34A is attached between the bottom of the upper articulated stinger member 22A and the top of the middle articulated stinger member 22B. A lower rigid locking link 34B is also attached between the bottom of the middle articulated stinger member 22B and the top of the lower articulated stinger member 22C. Insertion of the rigid locking links can be performed with, for example, any suitable hydraulic lock or latching mechanism. The rigid locking links 34A and 34B remove the ability of the stinger sections 22A, 22B, 22C to articulate relative to one another. Thus the stinger 12 becomes relatively rigid along its length in its collapsed configuration however, the middle and lower members are aligned along axis X and will remain so as long as the rigid locking links are present.

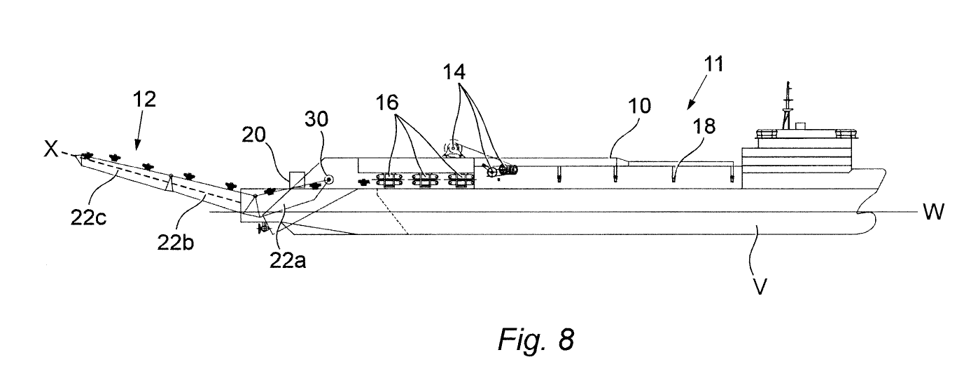

The tower 10 is now pivoted to the lowered, S-lay configuration around pivot 30. This causes the upper stinger member 22A, and hence the now rigidly connected middle and lower articulated stinger members 22B, 22C to rotate out of the water and above the waterline Was depicted in FIG. 8. The firing line roof doors 36 can then be closed. To return the stinger to the pipelaying operation the reverse procedure is performed to allow the rigid locking links to be disengaged from the articulated stinger members 22B, 22C.

With the stinger 12 above the water line W, the vessel can transit more efficiently since the drag in the water is greatly reduced. This also allows dry access to components of the stinger for repair and maintenance.

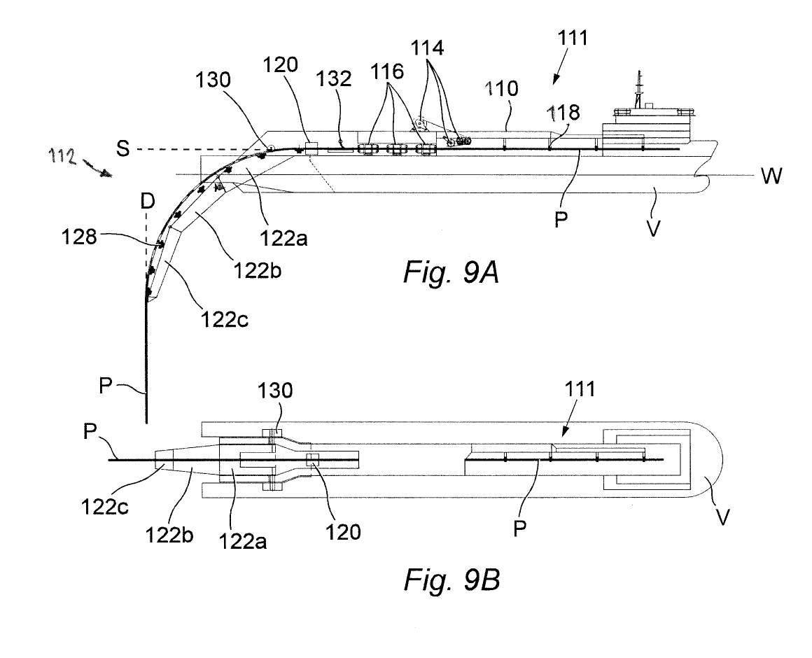

Referring to FIGS. 9 to 12, an alternative method of installing a module such as an ILT will be described. This alternative method can be performed with substantially the same equipment as previously described. In the following method, the ILT 132 is installed on the pipeline P prior to the tower 110 being pivoted into the temporary elevated configuration. This has the advantage of allowing the ILT 132 to be welded to the pipeline P whilst the pipeline P is horizontal. This can be more efficient than welding the ILT 32 to the pipeline P when it is elevated.

As with the previous method, during S-lay pipelaying operations, when the tower is lowered, sections of pipe are fabricated into the pipeline P at firing line 111 and are then passed along the rollerbox sections 118 of the tower 110 toward the stern of the vessel V. The pipeline P then passes through the tensioners 116 on the tower 110 to hold the weight of pipeline extending between the vessel V and the sea bed. Once passed through the tensioners 116, the pipeline P bends over the stinger 112 into the sea below, facilitated by the stinger roller box sections 128. Continued fabrication of the pipe at firing line 111 can therefore allow continuous laying of pipeline P from the vessel V.

When it is necessary to include a module on the pipeline P, the following steps are performed.

Fabrication of pipeline P at the firing line 111 is temporarily suspended.

The pipeline P being laid is then secured by a longitudinal hang-off clamp 120 which is in line with the S-lay fabrication axis S. Once the pipeline tension is restrained by the hang-off clamp 120, the pipeline P can be cut upstream of the hang-off clamp 120 (to the right of hang-off clamp 120 in FIG. 9A). The module, which in this case is an in line tee (ILT) 132, can then be attached between the end of the pipeline P and the remaining end section of fabricated pipe along the tower 110. Once the ILT 132 has been secured to the pipeline P, the hang-off clamp 120 is disengaged so that the weight of the pipeline P is once again held by the tensioners 116.

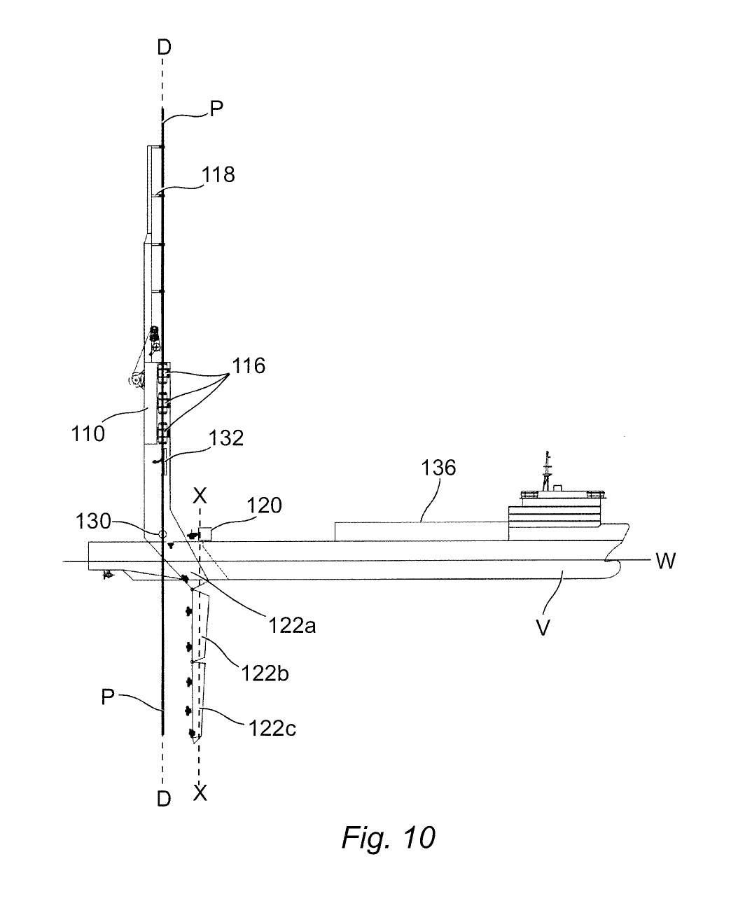

The firing line roof doors 136 are then opened and the tower 110 pivoted up on pivot 130 through approximately 90 degrees from its lowered configuration to a temporary elevated configuration depicted in FIG. 10. As the tower 110 pivots away from the lowered configuration toward the temporary elevated configuration, the tensioners 116 and the tower roller box sections 118 retain the upper end of the pipeline P and the installed ILT 132 within the tower 110. Since upper articulated stinger member 122A is rigidly coupled to the tower 110 it will also be retracted by pivoting toward the hull of the vessel V until it reaches the retracted axis X in a similar fashion as previously described.

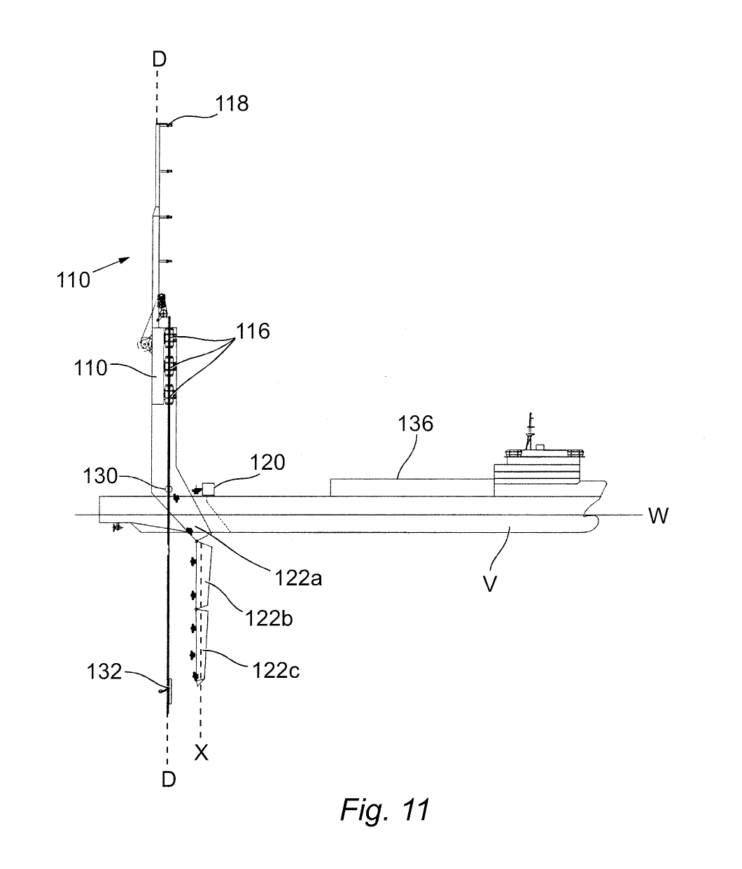

With the sections of the stinger 112 displaced from the departure axis D, the tensioners 116 can be actuated to slowly lower the section of pipeline P and the attached ILT 132 into the water. As shown in FIG. 11, this is continued until the ILT 132 is below the lowest point of the lower stinger section 122C. The ILT 132 has therefore now cleared the pipelaying equipment. The tower 110 will normally only lay a small section of pipeline in this temporary elevated configuration.

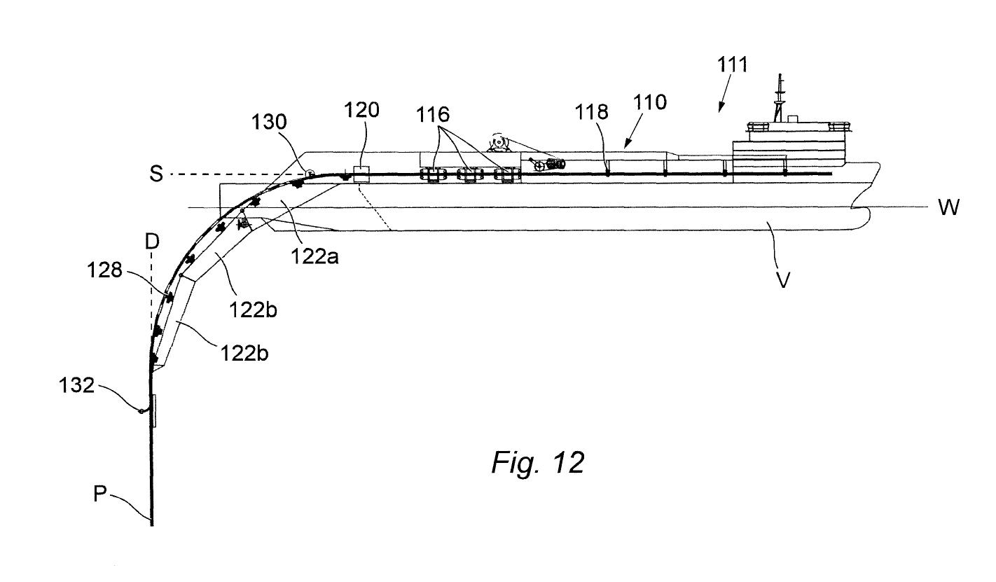

With the ILT 132 deployed, the tower 110 can now be returned to the S-lay configuration as shown in FIG. 12 for continued pipelaying as previously described.

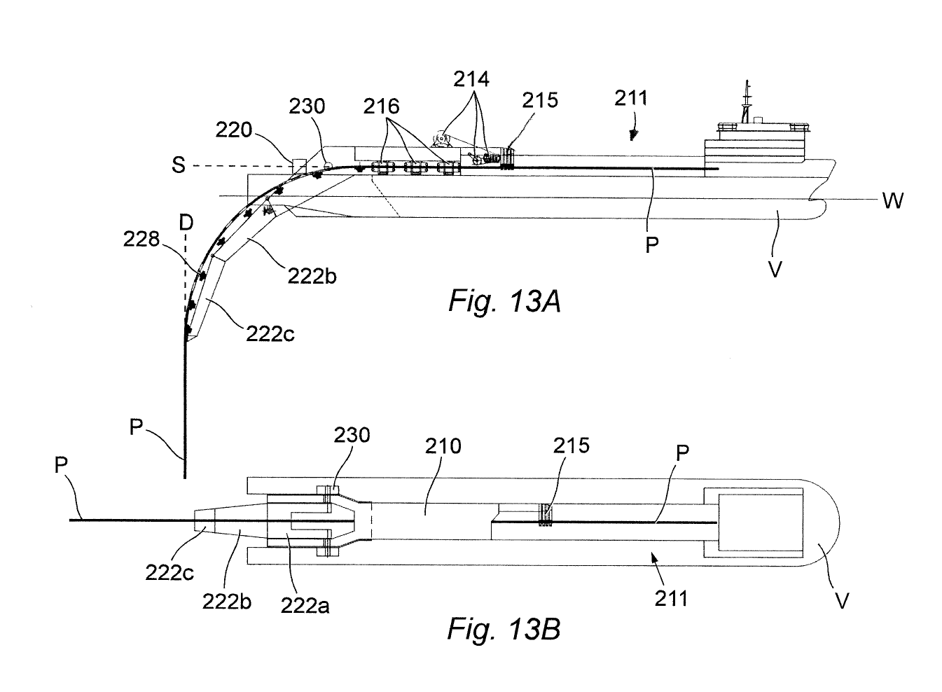

Referring to FIGS. 13 to 20, an alternative embodiment of the present invention will now be described. The features of this particular embodiment are substantially similar to those previously described with the particular exception that the tower 210 has a telescopic end arrangement 215 having roller box sections 218 along each telescopic extension.

In this embodiment, when it is necessary to include a module on the pipeline P, the following steps are performed.

Fabrication of pipeline P at the vessel firing line 211 is temporarily suspended.

The tensioners 216 then allow any pipeline P upstream of the tensioners 216 at the firing line 211 to pass through such that the end of the pipeline P being laid is adjacent the mouth of the tensioners 216.

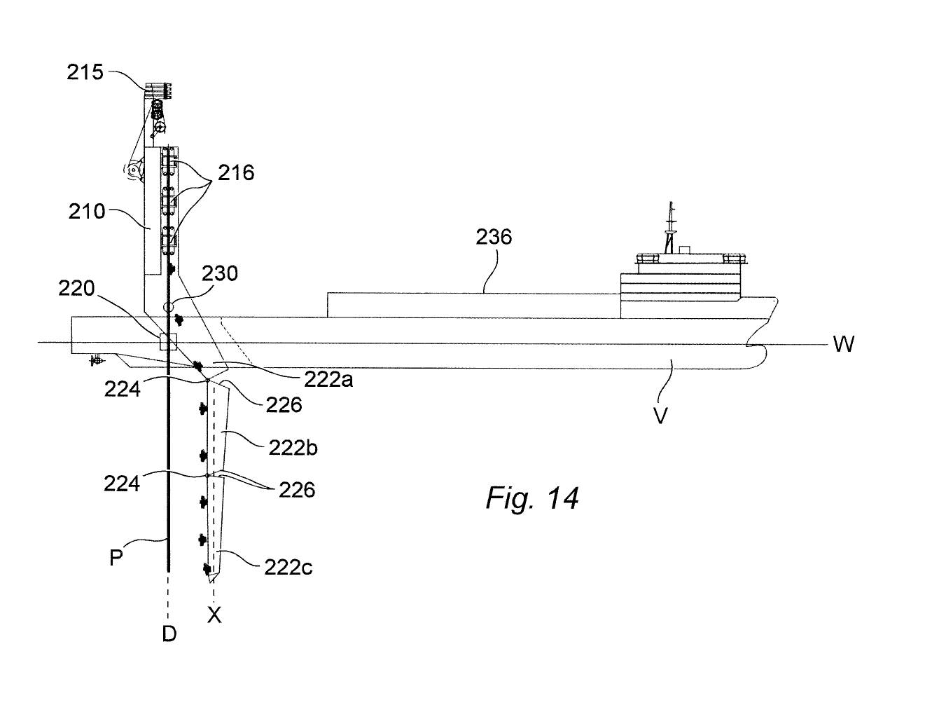

The tower 210 is then pivoted up on pivot 230 through approximately 90 degrees from its S-lay configuration to its temporary elevated configuration depicted in FIG. 14. As the tower 210 pivots away from the vessel's deck the tensioners 216 retain the upper end of the pipeline P in the retracted tower 210. Since upper stinger section 222A is rigidly coupled with the tower 210 it will also pivot towards the vessel V's hull and into a displaced position away from the departure axis D as previously described.

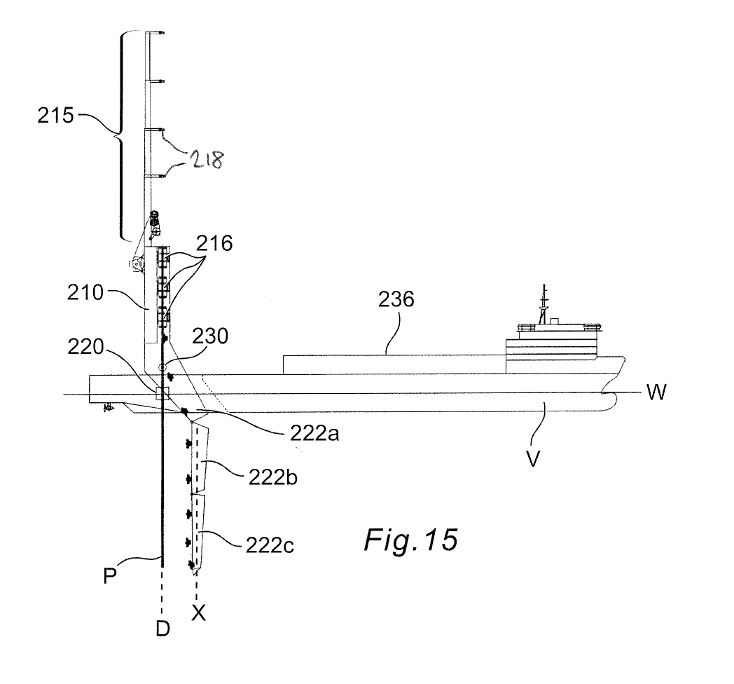

The telescopic end arrangement 215 on the tower 210 is then extended as depicted in FIG. 15 with assistance from any suitable actuator; for example a hydraulic or pneumatic actuator.

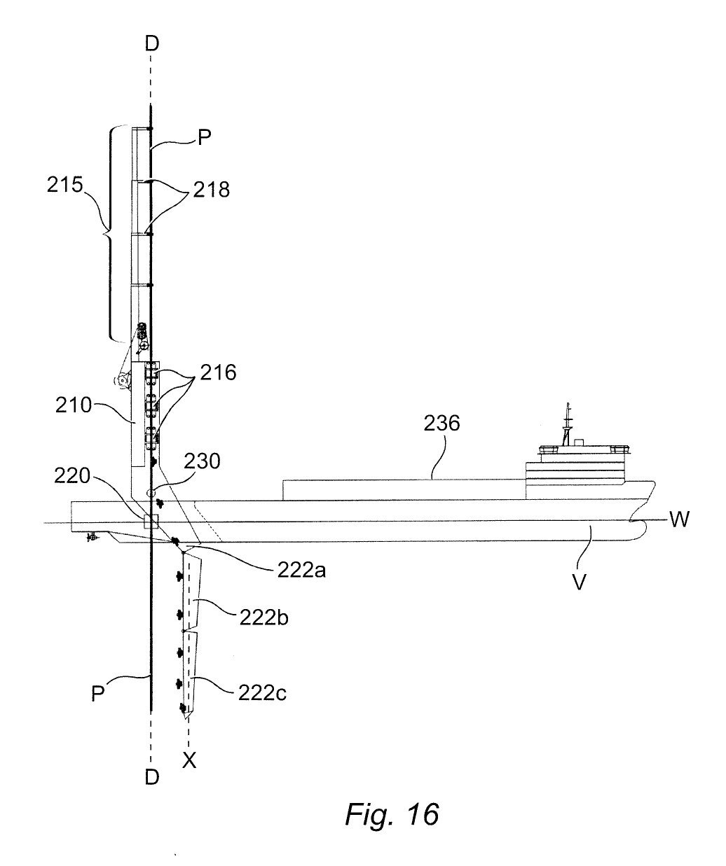

With reference to FIG. 16, the pipeline P must then be retracted up into the extended tower 215 before the module can be attached. This is performed by pulling in the pipeline P with the tensioners 16, or other means, until the end of the pipeline P reaches the top of the extended telescopic end arrangement 215. The pipeline P in the extended telescopic end arrangement 215 is secured by the roller box sections 218.

The pipeline P below the vessel is then secured by an upright hang-off clamp 220.

The pipeline P is then cut above the hang-off clamp 220. At this point the upper section of pipe in the extended telescopic end of the tower 210 is retained there by the tensioners 216.

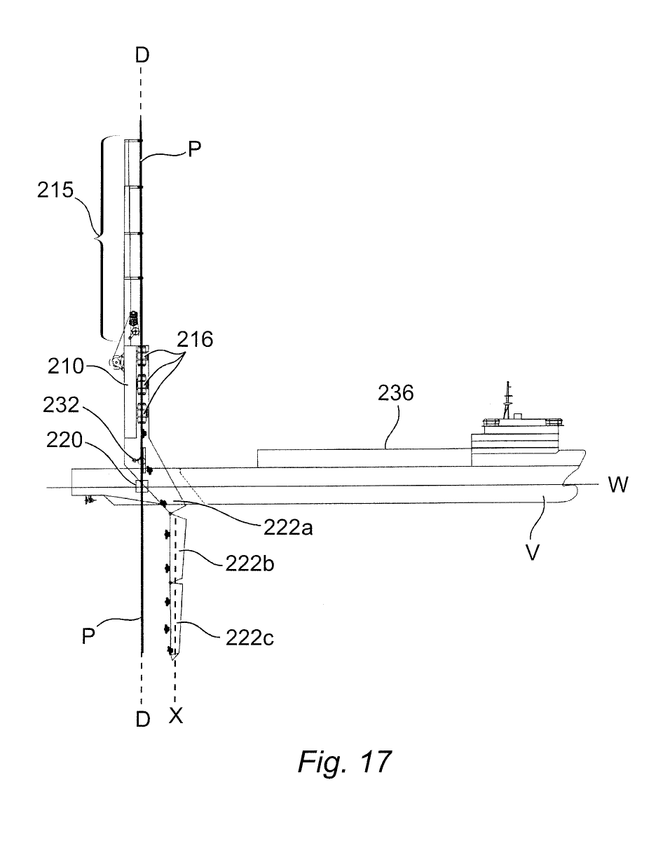

The module, which in this case is an ILT 232, can then be inserted between the bottom of the upper section of the pipe and the top of the lower section of pipe as shown in FIG. 17. Once the ILT 232 has been attached to the pipeline P, the hang-off clamp 220 is disengaged so that the weight of the pipeline P is once again held by the tensioners 216.

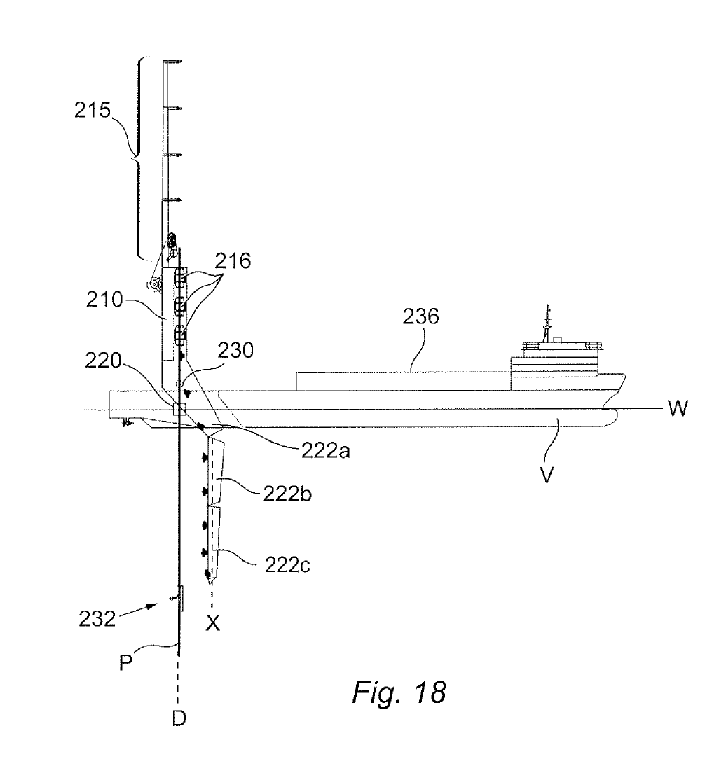

With the sections of the stinger 212 displaced from the departure axis D, the tensioners 216 can be actuated to slowly lower the upper section of pipeline P and the attached ILT 232 into the water below. As shown in FIG. 18, this is continued until the ILT 232 is below the lowest point of the lower stinger section 222C. The ILT 232 has therefore now cleared the pipelaying equipment.

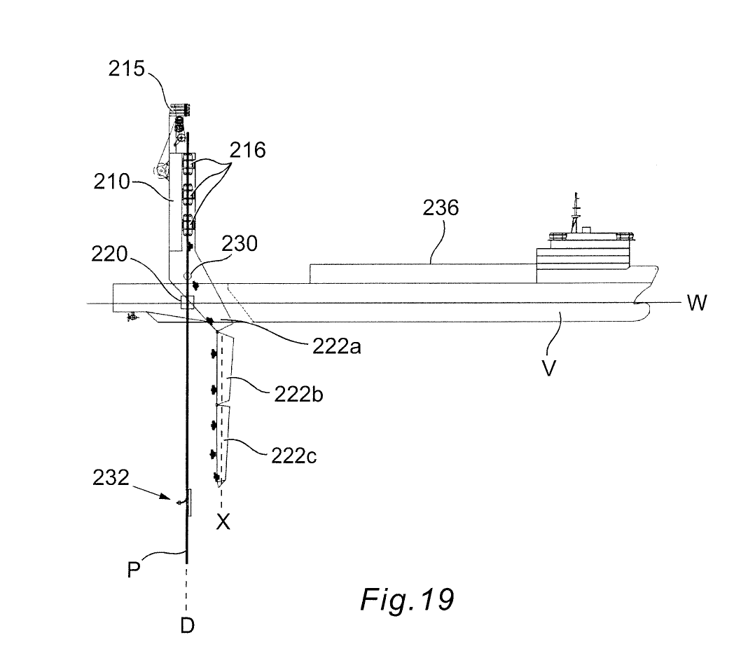

The telescopically moveable sections of the end arrangement 215 on the tower 210 are then retracted as depicted in FIG. 19.

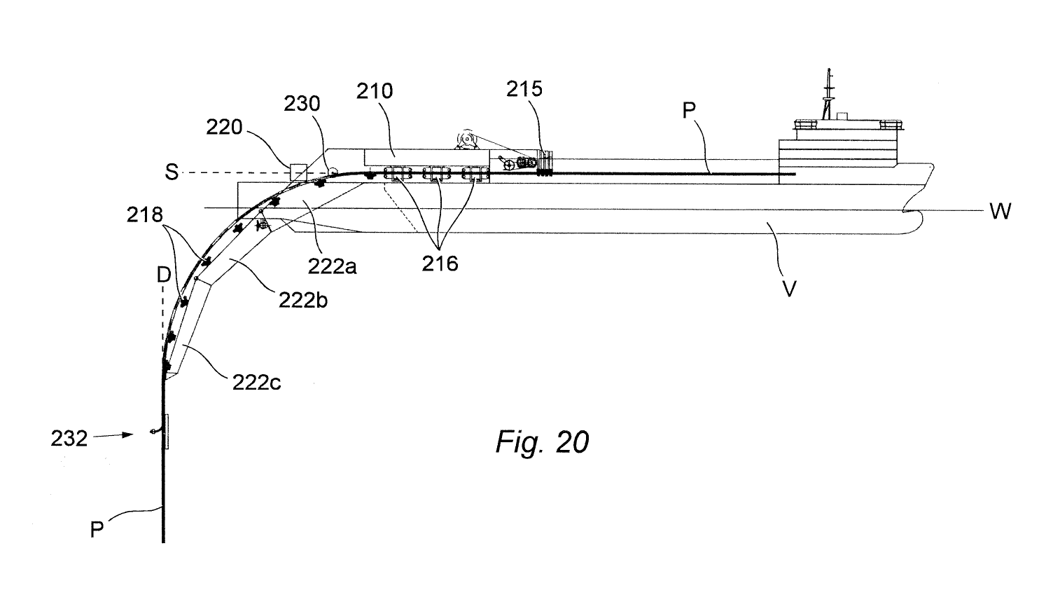

To return the tower 210 to the S-lay pipelaying configuration, the tower 210 is again pivoted back toward the vessel deck around the pivot 230 until it lies along the deck of the vessel V. As the tower pivots, the stinger 212 will also pivot as previously described and as shown in FIG. 20. Fabrication of pipeline P at the firing line and laying of the pipeline from the vessel V can then recommence.

In this embodiment it is not necessary to open and close the firing line doors 236 because the tower is normally only rotated whilst in its retracted configuration. The firing line equipment (not shown) is therefore better protected from the elements.

With this embodiment, the telescopic nature of the tower means that the vessel V can be much shorter than it would otherwise need to be to accommodate the tower when it is laid along the deck in the S-lay configuration.

Another advantage of the various embodiments of the present invention is that when the stinger is in the displaced configuration, it acts as a keel which stabilises the vessel and hence the tower in the water. The ability of the stinger to collapse as it is moved to the displaced configuration, although not essential, also reduces the torque force required to rotate the stinger toward its displaced configuration.

The S-lay technique was first developed for pipelaying in relatively shallow water. It benefits from a long production line with several working stations, and hence speeds the pipe fabrication process. In essence, the preceding embodiments of the invention employ a ‘Steep S-lay’ variant that adapts S-lay to deeper water by setting the lift-off point of the pipe from the stinger as close to vertical as possible. The pipe undergoes substantial strain in the overbend as it passes over the stinger, experiencing a deflection through substantially 90 degrees.

In Steep S-lay, the bending radius of the overbend should clearly be as large as possible to avoid exceeding the yield stress of the pipe. In this respect, the size and shape of the stinger determines the minimum bend radius of the overbend. Also, the diameter of the pipe is a key factor in its ability to follow the path of the overbend without exceeding its yield stress. For any reasonably-sized stinger, Steep S-lay may only be used where the diameter of the pipe is relatively small.

The J-lay technique, in contrast, involves welding single pipe sections or, preferably, multiple pipe joints onto the pipe end in an upright (i.e. substantially vertical or near-vertical) orientation in a J-lay tower. The pipe is launched downwardly into the water as it is formed, substantially aligned with the natural catenary curve of the free span of pipe suspended between the surface and the seabed. So, beneficially, the load on the pipe is substantially axial where it experiences maximum stress.

J-lay better suits large-diameter rigid pipes than S-lay. Also, J-lay is typically better than S-lay at handling accessories such as ILTs or other modules that must commonly be incorporated into a pipeline. However, where it can be used, S-lay (including Steep S-lay) is often preferred to J-lay for its inherently greater lay rate. This is why the tower 10, 110, 210 described in the preceding embodiments returns to the lowered S-lay configuration once a module such as an ILT 32 has cleared the pipelaying equipment.

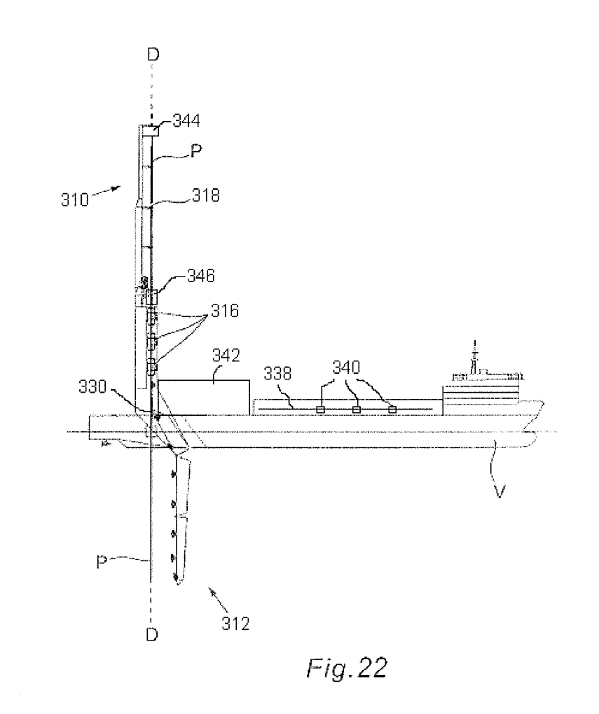

J-lay remains necessary for laying rigid pipes in deep water where the pipe diameter is too great to be laid using Steep S-lay. Also, the efficiency of J-lay is closer to that of S-lay when considering the overall laying rate of a pipeline including its accessories—as opposed to merely the rate of fabrication of a pipe—in view of the aforementioned disadvantages of S-lay when handling modules such as ILTs. Consequently, FIG. 22 of the drawings shows a further embodiment of the invention in which a tower 310 is adapted for J-lay operation when pivoted into, and left in, an upright orientation during pipelaying.

The J-lay system of this embodiment will typically handle triple- or quadruple joints 338 of rigid pipes. As is well known, such pipe joints 338 may be pre-assembled on shore or may be welded on board the vessel V. Conveniently, on-board fabrication of the pipe joints 338 may be achieved using deck-level welding/NDT/coating stations 340 as used in the same generally horizontal firing line of the preceding S-lay embodiments. Those stations 340 remain on the deck of the vessel V when the tower 310 elevates.

Pipe joints 338 are conveyed to a pipe loader and elevator system shown schematically as 342, which raises and upends the pipe joints 338. The pipe loader and elevator system 342 is of well-known construction but should be disposed to one side of the S-lay firing line to provide clearance for S-lay operations. A winch 344 lifts the upended pipe joints 338 into the upright tower 310 where they are supported by rollerboxes 318.

A welding/NDT station 346 is located above the tensioners 316, where the pipe joints 338 are aligned with and welded to the upper end of the pipe string held by the tensioners 316, and the weld is tested. If necessary, moveable clamps (not shown) may interact with the tensioners 316 in a well-known ‘hand-over-hand’ process to lower the pipe string.

A separate coating station (not shown) may be provided below the tensioners 316.

The welding/NDT station 346 and the coating station are preferably attached to and movable with the tower 310. However if those stations would interfere with S-lay operations when the tower 310 is lowered, they could be movable with respect to the lowered tower 310 out of the S-lay firing line. Alternatively, it would be possible to support at least one of those stations on a fixed structure against which the tower 310 is raised.

Whilst drawn vertically in FIG. 22, the tower 310 will usually be inclined to launch the pipe P at an off-vertical angle of say 5° to 25° to avoid buckling the pipe P under horizontal loads exerted on the pipe P between the seabed and the vessel V. The desired launch angle will vary in different circumstances and so it is preferred for the tower 310 to be pivotable about pivot 330 into various operational angles with respect to the vertical.

It is also possible—although not shown here—for the tower 310 to be pivotable about an additional horizontal axis orthogonal to that of the pivot 330, whereby the tower 310 may gimbal with respect to the hull of the vessel V. A gimballing facility may, for example, be useful where the vessel V is turned into the wind or current and so the longitudinal axis of its hull is not aligned with the direction of travel and hence of pipelaying.

Whilst the tower 310 will remain in an upright near-vertical position during J-lay operations, it may be lowered for conversion to S-lay operations or for stability in bad weather or during transit.

During J-lay operations, the stinger 312 will generally remain in the retracted configuration as shown, displaced from the departure axis D of the pipe P. However, it is known to employ stingers in J-lay operations and therefore a suitably-arranged stinger could be re-configurable and movable to support the pipe P in a manner appropriate to J-lay.

Whilst there may be advantages in leaving the stinger 312 hanging in the water even if it is not in use supporting the pipe P, it would also be possible to design a stinger to lift partially or completely clear of the water during J-lay operations. For example, the stinger could be pivotably mounted to a carriage (not shown) that is movable laterally with respect to the hull of the vessel to allow the stinger to lift past the pipe. This is also a way of lifting the stinger out of the water for transit and docking purposes, as an alternative to the arrangement shown in FIG. 8.

By virtue of this embodiment of the invention, conversion from S-lay to J-lay operations and vice versa may be achieved very quickly, at sea if required, and without the assistance of support vessels. This is in contrast to prior art proposals in which a vessel may only be converted from S-lay to J-lay operations or vice versa over a lengthy period of a week or more, and usually only when docked. Clearly, such downtime is undesirable in the context of vessels that are hugely-expensive capital assets and are in high demand around the world.

The only other option proposed in the prior art is to have separate J-lay and S-lay apparatus provided together on the same vessel, which is clearly an expensive solution as it requires not just that duplication of apparatus but also a larger vessel.

Modifications and improvements may be made to the foregoing without departing from the scope of the invention, for example:—

The module referred to in the above method and apparatus is an ILT; however, the method and apparatus are equally applicable to any module which is not suited to deployment in an S-lay laying operation. For example, it could be substituted for an end termination such as a PLET. For a first end PLET, substantially the same method of deployment may be employed. For a second end PLET the pipeline and PLET are lowered on an abandonment and recovery wire and winch. The angle of the tower can then be altered to align with the curvature of the pipeline suspended beneath the vessel during deployment.

The embodiment described illustrates laying of a pipeline P from the stern of a vessel V; however, the method and apparatus is also suitable for laying pipe from the bow of a vessel and/or a moon pool in the deck of the vessel.

Rather than rigidly attaching the tower and the stinger, the stinger and tower could alternatively be independent members which are independently moveable around their own pivots.

Although the drawings illustrate the tower in a vertical or near vertical position when in the elevated configuration similar benefits may be provided without pivoting the tower to the vertical.

The elevated configuration previously described is therefore not limited to a vertical configuration but rather refers to the tower being upended by a degree which allows laying of the pipeline along a departure axis when the stinger is at least partly displaced. For example, in a shallow laying operation, the tower may only need to be slightly raised to a partly elevated configuration which is only slightly angled with respect to the fabrication axis in order to allow the module to clear the stinger.

The embodiments described have either a three-sectioned stinger or a two-sectioned stinger. The reader will appreciate that the stinger could alternatively comprise a single-sectioned stinger or indeed a multi-sectioned stinger having more than three sections. This could be varied as required in any particular application with minimal or no modification to the surrounding apparatus being required.

Certain features in the various embodiments described are not exclusively applicable to those embodiments but are in fact also applicable to the other embodiments. For example, the extendable tower embodiment of FIGS. 13 to 20 although shown with a hang-off clamp downstream of the pivot (for attaching the module when the tower is elevated) could equally be provided with a hang-off clamp upstream of the pivot (for attaching the module when the tower is horizontal) as shown in FIGS. 9 to 12.

1-53. (canceled)

54. A method of laying pipeline from a vessel having pipelaying equipment that includes:
pipeline fabricating apparatus, the pipeline fabricating apparatus having a fabrication axis disposed at less than 45 degrees to horizontal;
a stinger pivotable between a deployed configuration, wherein in the deployed configuration the stinger supports the fabricated pipeline in an arcuate path between said fabrication axis and a departure axis, wherein the departure axis is aligned with pipeline suspended beneath the vessel, and a retracted configuration; and
a tower pivotable between a lowered configuration in which the tower lies substantially parallel with the fabrication axis and an elevated configuration in which the tower is substantially aligned with the departure axis, the method comprising the following steps:
a) pivoting the stinger away from the deployed configuration and into the retracted configuration and pivoting the tower away from the lowered configuration and into the elevated configuration when it is desired to attach a module to the pipeline;
b) before or after step a) attaching a module to the pipeline;
c) lowering the section of pipeline from the tower along the departure axis at least until the attached module is below the retracted stinger; and
d) pivoting the stinger away from the retracted configuration and into the deployed configuration and pivoting the tower away from the elevated configuration and into the lowered configuration to allow continued laying of fabricated pipeline;
further comprising supporting the pipeline by way of the tower during pivoting between the elevated and lowered configurations.

55. A method according to claim 54 comprising supporting the pipeline by way of the tower during fabrication of the pipeline from pipe elements and during an S-lay operation when the tower is in the lowered configuration.

56. A method according to claim 54, further comprising coupling the tower and stinger with one another for simultaneous movement such that in steps a) and d) each serves as a counterweight for the other.

57. A method according to claim 54, further comprising decoupling the tower and stinger members and independently moving each between their respective lowered and elevated configurations.

58. A method according to claim 54, wherein the tower further comprises tensioning apparatus, the method further comprising providing support during steps a) and d) by supporting the suspended pipeline on the tensioning apparatus provided on the tower, where the tensioning apparatus pivots with the tower so that the same tensioning apparatus can then be used to control deployment of the pipeline when in the lowered and elevated configurations.

59. A method according to claim 54, wherein the tower further comprises a hang-off clamp, the method further comprising providing support during steps a) and d) by the hang-off clamp provided on the tower such that abandonment and recovery apparatus can then be used to control deployment of the pipeline when in the elevated configuration.

60. A method according to claim 54, wherein pivoting the stinger into the retracted configuration in step a) further comprises moving articulated stinger sections such that they collapse out of rigid engagement with one another when the stinger is in its retracted configuration.

61. A method according to claim 54 further comprising the providing the tower in a retracted configuration and selectively extending the length of the tower to an extended configuration.

62. A method according to claim 54, wherein when it is desired to configure the vessel for non-pipelaying operations, the method further comprises:
at least partially pivoting the tower from its lowered configuration toward its elevated configuration and hence at least partially pivoting the stinger into its collapsed, retracted configuration;
rigidly retaining at least a portion of the stinger in its collapsed configuration; and
returning the tower toward its lowered configuration thereby at least partially lifting the stinger into line with the vessel's longitudinal axis.

63. A method according to claim 54, wherein when it is desired to perform a hand over operation, the method further comprises:
at least partially lowering the end of the pipeline below the vessel;
maneuvering the vessel around the lowered pipeline; and
pivoting the tower further past its elevated configuration into a hand over configuration.

64. Pipelaying equipment for laying pipeline from a vessel, the equipment comprising:
pipeline fabricating apparatus for fabricating pipeline, the pipeline fabricating apparatus having a fabrication axis disposed at less than 45 degrees to horizontal;
a stinger which is pivotable between a deployed configuration, wherein in the deployed configuration the stinger supports the fabricated pipeline in an arcuate path between said fabrication axis and a departure axis which is aligned with pipeline suspended beneath the vessel, and a retracted configuration; and
a tower pivotable between a lowered configuration in which the tower lies substantially parallel with the fabrication axis and an elevated configuration in which the tower is substantially aligned with the departure axis, wherein tower is adapted to support the pipeline during pivoting between the elevated and lowered configurations.

65. Pipelaying equipment according to claim 64, wherein the tower and stinger are coupled such that they can pivot together as a unit, each serving as at least a partial counterweight for the other.

66. Pipelaying equipment according to claim 64, wherein the tower and stinger are independently moveable.

67. Pipelaying equipment according to claim 64, comprising a pipeline support mounted to the tower such that the pipeline support will pivot along with the tower between the lowered and elevated configurations to thereby support the pipeline at and between these two configurations.

68. Pipelaying equipment according to claim 64, wherein the stinger comprises a single stinger member mounted at one end of the vessel at a pivot axis which is common to the tower pivot axis.

69. Pipelaying equipment according to claim 64, wherein the stinger comprises a plurality of articulated stinger members, at least one of which is mounted at one end to the vessel at a common pivot axis and which, in a first operational configuration, closes into engagement with another of the articulated stinger members to provide a relatively rigid stinger member and in a second, retracted configuration collapses out of rigid engagement with the other articulated stinger members.

70. Pipelaying equipment according to claim 69, wherein locking members are provided to selectively retain the articulated stinger members in the collapsed configuration for stowage.

71. Pipelaying equipment according to claim 64, wherein the tower comprises telescopically moveable sections adapted to allow the tower to actuate between a retracted configuration and an extended configuration.

72. Pipelaying equipment for laying a pipeline from a vessel, the equipment comprising a tower pivotable between a lowered configuration in which the tower lies substantially parallel with a pipe fabrication axis that is closer to horizontal than vertical and an elevated configuration in which the tower is substantially aligned with a departure axis of pipeline suspended beneath the vessel; wherein the tower comprises supports capable of supporting a length of the pipeline on the fabrication axis; the apparatus further comprising a pipe elevator system, wherein the equipment is configured for an S-lay operation when the tower is in the lowered configuration, with pipe elements being added to the pipeline in substantial alignment with the fabrication axis; and the equipment is configured for a J-lay operation when the tower is in the elevated configuration, with pipe elements being raised and oriented by the pipe elevator system and added to the pipeline in substantial alignment with the departure axis.

73. Pipelaying equipment according to claim 72, wherein at least one tensioner is provided on and pivotable with the tower.

74. Pipelaying equipment according to claim 72, wherein welding, testing and/or coating stations positioned for the S-lay operation are also adapted to be usable to prepare pipe elements for use in the J-lay operation.

75. A method of laying pipeline from a vessel, comprising pivoting a tower between a lowered configuration in which the tower lies substantially parallel with a pipe fabrication axis that is closer to horizontal than vertical and supports a length of the pipeline during its fabrication, and an elevated configuration in which the tower is substantially aligned with a departure axis of pipeline suspended beneath the vessel; the method further comprising conducting an S-lay operation when the tower is in the lowered configuration, with pipe elements being added to the pipeline in substantial alignment with the fabrication axis; and conducting a J-lay operation when the tower is in the elevated configuration, with pipe elements being raised, oriented and added to the pipeline in substantial alignment with the departure axis.

76. A method according to claim 75, comprising supporting the pipeline by means of the tower through a series of welding, testing and/or coating operations performed along the fabrication axis.

77. A method according to claim 75, comprising pivoting a supported length of the pipeline with the tower when the tower pivots between the lowered and raised configurations.

78. A method according to claim 75, comprising using welding, testing and/or coating stations for the S-lay operation also to fabricate pipe elements for the J-lay operation.
